(19) United States
(12) Patent Application Publication
(10) Pub. No.: US 2024/0182289 A1
(43) Pub. Date: Jun. 6, 2024

(54) BEVERAGE DISPENSING MACHINE NETWORK

(71) Applicant: Vendometry Inc., Edmonton (CA)

(72) Inventor: David Kennedy, Edmonton, AB (CA)

(21) Appl. No.: 18/556,595

(22) PCT Filed: Apr. 21, 2022
(86) PCT No.: PCT/CA2022/050613

§ 371 Date: Oct. 20, 2023

Related U.S. Application Data
(60) Provisional application No. 63/177,756, filed on Apr. 21, 2021.

(51) Int. Cl. B67D 1/08; A47J 31/00; H04M 1/72436

(52) U.S. Cl. CPC B67D 1/0878; A47J 31/007; H04M 1/72436

(57) ABSTRACT

A system is provided for monitoring a plurality of beverage dispensing machines. A monitoring device associated with each machine includes a sensor for generating data indicative of a product level, machine usage, or machine error. A control computer receives the data, generates a notification (such as an alert, a report, or a servicing schedule) based on the data, and transmits the notification to a mobile computer. The monitoring device may include a signal generator, and a processor configured to control the signal generator to generate a machine reset signal in response to receiving a reset request from a communications network.

### CROSS-REFERENCE TO RELATED APPLICATION

This application claims priority to and the benefit of U.S. Provisional Patent Application No. 63/177,756, filed on Apr. 21, 2021, titled “BEVERAGE DISPENSING MACHINE NETWORK”, the entire contents of which are incorporated herein by reference.

### FIELD OF THE INVENTION

The disclosed invention relates to systems and methods for monitoring and servicing beverage dispensing machines, and coffee dispensing machines in particular.

### BACKGROUND OF THE INVENTION

Typically, coffee dispensing or vending machines operate to prepare and dispense a cup of coffee automatically, which may involve steps of grinding coffee beans or dispensing ground or dehydrated instant coffee, heating water and passing it through the ground or instant coffee, adding a sweetener and/or milk or cream if desired, and dispensing into a cup. In some cases, a flavored beverage powder may be used or added. Automated machines may use pods or single serving containers.

Many businesses provide coffee for their employees and/or customers as part of their normal operations, and have outsourced the provision of coffee machines to an outside supplier. These suppliers typically provide the machines, and are responsible for stocking the machines with required supplies and for repair and maintenance.

Conventionally, emergency repairs require on-site service, which may be time-consuming and expensive. Also, representatives or technicians may be called by the business to routinely replenish supplies or repair/maintain machines, however, it is more likely that the supplier will schedule routine visits on a periodic basis. Regular service visits must be scheduled frequently enough that the risk of machines running out of necessary supplies is minimized. However, regular periodic visits typically occur more frequently than necessary.

It would be more efficient, and therefore more cost-effective, if such visits occurred on an as-needed basis, as opposed to a regular schedule, or if such visits were obviated by remote troubleshooting and service. Therefore, there is a need in the art for a monitoring and servicing system which automatically determines service needs and schedules in an efficient manner.

### SUMMARY OF THE INVENTION

Generally, in one aspect, the invention comprises a system comprising a control computer for monitoring, maintaining or servicing a plurality of beverage dispensing machines, wherein each dispensing machine has a known location, said control computer comprises a processor and a memory including computer program code, the memory and the computer program code configured to, with the processor, cause the control computer to receive product level data and/or usage data from each of the plurality of dispensing machines, determine which dispensing machines require a service visit and an estimated time of the visit, and determine an optimized servicing schedule itinerary for service visits, wherein the itinerary is optimized to reduce distance travelled and total service visits made.

In some embodiments, the control computer comprises at least one monitoring device, and the control computer is operatively connected to the monitoring device to receive data from the monitoring device. The monitoring device comprises (a) at least one product sensor for directly or indirectly determining a product level in the dispensing machine and/or at least one usage sensor operatively connected to a counter for determining a number or elapsed time of dispensing machine activations: and (b) a communication module for transmitting data produced by the product sensor and/or the usage sensor to the control computer. In some embodiments, the communication module may be configured to receive data from a mobile computer used by an operator, which allows the operator to maintain, reconfigure, repair and/or reset the dispensing machine remotely.

In some embodiments, the monitoring device may further comprise:
(a) at least one sensor operatively connected to the power circuit, to determine directly or indirectly if the machine was inadvertently shut off and/or broken into: and/or
(b) at least one sensor operatively connected to a product or a product dispensing mechanism, to determine directly or indirectly a water level.

In some embodiments, the control computer is configured to receive product level data and/or usage data from the monitoring devices operatively connected to each of the plurality of dispensing machines, store information regarding service visits made, and create a report in connection with each dispensing machine, either on a periodic or on-demand basis (i.e. in response to a request received from a mobile computer), wherein the report may comprise an invoice amount owing, data representative of consumption and billing rates, and/or service visits made. The report may comprise information which provides business intelligence for the business operator and/or for the control computer operator.

In some embodiments, the report or a portion of the report may be transmitted by the control computer to a computer used by a customer, and may comprise an invoice, a maintenance record for all operation, maintenance, and/or safety needs. This maintenance record may be used to ensure parts are replaced on a timely basis. The maintenance record may link to an ordering portal where the customer may order required or desired supplies or parts.

In some embodiments, the customer ordering process may be completely automated, whereby ordering is automatically linked to product or supply levels, and delivery is scheduled when necessary.

In some embodiments, the control computer determines the optimized servicing schedule itinerary based on data comprising one or more of historical consumption, predicted consumption rates, usage data, other operational data, servicing data, and malfunction data relating to the dispensing machine. Predicted consumption rates may be determined based on factors such as current usage rates, strength settings, densities of products, and/or dosages. In some embodiments, the control computer uses a machine learning model to process the data to determine a service action for the servicing schedule, for preventative maintenance to avoid malfunctioning of the dispensing machine.

In some embodiments, the monitoring device associated with each dispensing machine is configured to send a notification to the control computer in the event the monitoring device associated with the dispensing machine determines that the dispensing machine is out of or running low of a product, needs a reset for any reason, has been powered off, or has experienced a power disruption.

### BRIEF DESCRIPTION OF THE DRAWINGS

Referring to the drawings, several aspects of the present invention are illustrated by way of example, and not by way of limitation, in detail in the figures/.

FIG. 1 is a schematic depiction of a system as disclosed herein in a communications network.

FIG. 2 is a schematic flowchart of a usage and maintenance cycle.

FIG. 3 is a schematic flowchart of a refill cycle.

FIG. 4 is a schematic flowchart of a dispensing machine setup cycle.

FIG. 5 is a schematic diagram of a monitoring device.

FIG. 6 is a schematic flowchart of a monitoring device process.

FIG. 7 is a schematic flowchart of an embodiment of a method that employs a machine learning model to predict servicing requirements for a dispensing machine, as implemented by the system disclosed herein.

### DETAILED DESCRIPTION OF THE INVENTION

The present invention now will be described more fully hereinafter with reference to the accompanying drawings, in which some, but not all embodiments of the invention are shown. Indeed, this invention may be embodied in many different forms and should not be construed as limited to the embodiments set forth herein; rather, these embodiments are provided so that this disclosure will satisfy applicable legal requirements. Like numbers refer to like elements throughout. It is to be understood that this invention is not limited to the particular methodology and protocols described, as such may vary. It is also to be understood that the terminology used herein is for the purpose of describing particular embodiments only, and is not intended to limit the scope of the present invention.

As used herein, a “beverage” is meant to include any liquid meant for consumption, such as tea, coffee, hot or cold chocolate, milk, soup and the like. A “product” is any material or ingredient which is consumed in the process of making the beverage by a beverage dispensing machine, such as, without limitation, coffee beans or grounds, tea leaves, a concentrate, water or other liquid, cups or containers, or any other consumable material or ingredient, whether or not such product is supplied in a package such as a pod, capsule, or bag.

“Processor”, as used herein, refers to one or more electronic devices that is/are capable of reading and executing instructions stored on a memory to perform operations on data, which may be stored on a memory or provided in a data signal. Non-limiting examples of processors include devices referred to as microprocessors, microcontrollers, central processing units (CPU), and digital signal processors. The term “processor” includes a plurality of physically discrete, operatively connected devices despite use of the term in the singular.

“Memory” or “computer memory”, as used herein, refers to a non-transitory tangible medium for storing information in a format readable by a processor, and/or instructions readable by a processor to implement an algorithm. Non-limiting types of memory include solid-state, optical, and magnetic computer readable media. The term “memory” includes a plurality of physically discrete, operatively connected devices despite use of the term in the singular. Instructions stored by a memory may be based on a plurality of programming languages known in the art, with non-limiting examples including the C, C++, Python, MATLAB, and Java programming languages. The memory stores instructions executable by the processor to implement one or more embodiments of the method of the present invention, as described below. The memory storing such instructions may be considered to be a computer program product of the present invention.

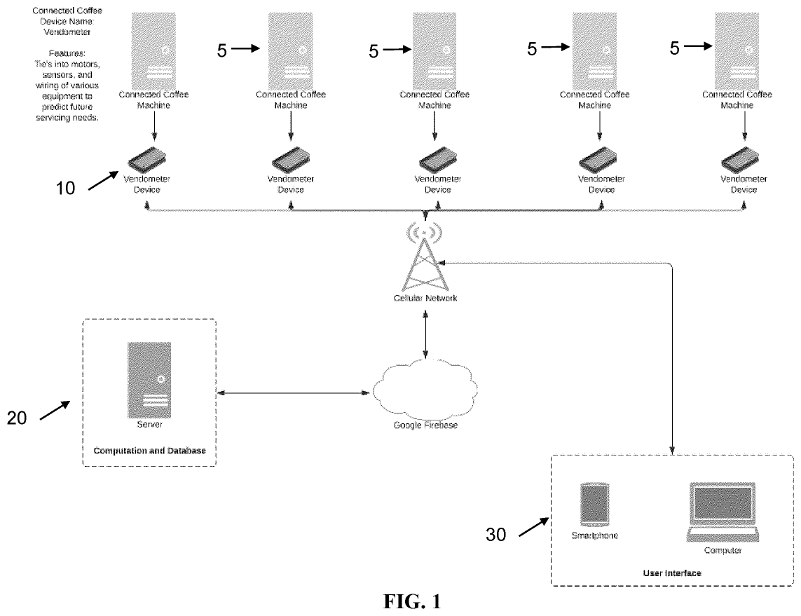

Generally, as shown in one embodiment in FIG. 1, the invention comprises a system for monitoring, maintaining or servicing a plurality of beverage dispensing machines (5), wherein each dispensing machine has a known location. The system comprises three subsystems. A first subsystem comprises monitoring devices (10), each of which is included in or operatively connected to one of the dispensing machines (5), and each of which comprises:
(a) at least one product sensor for directly or indirectly determining a product level in the dispensing machine (5):
(b) at least one usage sensor operatively connected to a counter for determining a number or elapsed time of machine activations of the dispensing machine (5): and
(c) a communication module for transmitting data produced by the product sensor and/or the usage sensor to a central control computer (20).

The second subsystem is a control computer (20) which communicates with the monitoring devices (10), and which is configured to perform various functions as described below.

The third subsystem comprises a mobile computer (30) running a mobile service application (app), which communicates with the control computer (20), and which provides a user interface for a service technician user to receive notifications or alerts, and to input relevant data and information.

In some embodiments, the beverage dispensing machine (5) is a coffee making machine, which operates in a conventional fashion. For example, upon selection by a user, the machine may measure out a portion of pre-ground coffee, or grind a portion of coffee beans, heat and pass water through the ground coffee, add milk, cream, sugar or sweetener as selected by the user, and dispense the coffee into a cup. All of these products are stored within the machine (5), and must be replenished from time to time. The operating mechanism typically relies on motors and actuators which are configured to perform well understood mechanical tasks. The machine (5) may also provide other hot beverages, such as tea or hot chocolate.

In some embodiments, the at least one product sensor for determining a product level is operatively connected to a product storage container to directly measure the product level, and may comprise a level sensor such as a float or other liquid or solid level sensor. For example, if the product comprises items which may be counted discretely, then the product sensor may be a product counter, able to specify numerically the product number. In some embodiments, the product sensor may indirectly determine the product level by determining usage and thus may comprise any mechanism which provides information about the amount of product which has been consumed, or which is available to the machine. In some embodiments, the product sensor may determine the amount of product consumed or remaining by determining a usage interval for a dispensing mechanism, such as a motor which actuates a pump or other product dispenser. For example, the product sensor may comprise a connection which detects a voltage applied to a motor, which is indicative of the motor being operated. The dispensing rate of the mechanism is known, and thus the length of time it is in use provides a measure of product dispensed.

In some embodiments, the at least one usage sensor operatively connected to a counter or clock for determining total number or length of time of machine activations comprises a mechanical or electronic mechanism which keeps track of the number of uses and/or total time of operation of the machine (5). Some service or maintenance tasks may be dependent on total usage, whether by number of beverages dispensed or by time in operation.

This information or data is collected by the monitoring device (10) which is integral with or operatively connected to the beverage dispensing machine (5). The monitoring device (10) may be wired directly into the machine (5) or may receive information wirelessly through conventional wireless transmission protocols and systems attached to or forming part of the machine (5).

In some embodiments, the plurality of monitoring devices (10) which are connected by their communications modules (e.g., a modem for cellular, wireless or wired data transmission and reception) to a communications network, for example, the Internet, a local area network such as a WLAN, and/or or a wide area network, such as 3G, 4G or 5G cellular mobile networks.

The mobile computer (30) may be a smartphone or tablet computer with a processor and memory, and also communicates with the monitoring devices (10) and the control computer (20), such as by a cellular mobile network. The mobile service app running on the mobile computer (30) may be operated by service technicians who maintain or repair the beverage machines, and/or refill products into the machines.

The mobile computer (30) may be any portable computing device used by the customer or a service technician, which device has an electronic display screen, and a communication means for transmitting and receiving data wirelessly. For some embodiments of the system and method of the present invention, it will also be required that the mobile computer (30) have input means for the user to enter information (e.g., a touchscreen and/or physical keyboard), and means for determining the location of the mobile computer (e.g., a GPS receiver and processor). As a non-limiting example, the mobile computer (30) may be a handheld tablet computer or smartphone operating on the Android™ or iOS™ operating system, and capable of wireless data transmission and reception via one or more of cellular (e.g., 4G and/or 5G standard), Wi-Fi, and Bluetooth™ protocols.

The mobile service apps may be configured to receive alerts or notifications generated by the control computer (20) to service or maintain a dispensing machine (5). The mobile service app may also be configured to allow the user to enter actual product levels in order to update, reset, or refine inferred product levels stored in the control computer (20), and to reset or clear any alert or notification after a service visit is complete.

In one aspect, the system comprises a control computer (20) which gathers or receives the data or information from the monitoring devices (10) and the mobile computers (30) running the mobile service apps, and processes the same to make service and/or maintenance determinations.

The control computer (20) is a computer device that is distinct from the user mobile computer (30), and comprises a processor. The control computer (20) is operatively connected to the monitoring devices (10) to receive and store data or information generated by the monitoring devices (10). The control computer (20) may comprise or have access to a database for storing and retrieving current and historical data generated by the monitoring devices (10) and mobile computers (30).

Thus, the control computer (20) may comprise a processor and a memory including computer program code, the memory and the computer program code configured to, with the processor, cause the control computer (20) to receive product level data and/or usage data, and other operational data from each of the plurality of monitoring devices (10), each corresponding to one of the dispensing machines (5), determine which dispensing machines (5) require a service visit, and notify a mobile computer (30) to schedule such as visit.

The control computer (20) may implement scheduling algorithms which optimize service or maintenance schedules, having regard to location of the dispensing machines (5), the timing of required service or maintenance, or predicted service or maintenance requirements. The control computer (20) may determine an estimated time of the visit, determine an optimized servicing schedule itinerary for service visits, wherein the itinerary is optimized to reduce distance travelled and total service visits made. The control computer (20) may employ machine learning or artificial intelligence methods to refine its predictions and optimizations for servicing requirements (see Example 5).

For example, the control computer (20) may determine that a number of dispensing machines (5) which are relatively close to each other geographically will each require service within a relatively short period of time. The control computer (20) may then generate and transmit alerts or notifications to the mobile computer (30) to prompt a service advisor to schedule a service or maintenance visit to each of the machines in one trip, at a time which is on or before the anticipated scheduled dates. If the service or maintenance visit is not critical, the control computer (20) may permit some visits to occur shortly after a scheduled date.

In the scheduling algorithm, a priority level may be given to a dispensing machine (5) which has failed or which is predicted to run out of a product imminently. For example, the control computer (20) may immediately schedule a visit to such a machine (5), and then add in service visits to machines (5) in the geographic vicinity which may not require replenishment or service for a time into the future, but for which it may be convenient and efficient to “top up” or perform preventative maintenance on the same itinerary.

The scheduling algorithm may also determine service times to avoid conflict with peak usage periods of a particular dispensing machine (5). Based on the data gathered from the product sensor, usage sensor and/or other sensors of a monitoring device (10), the control computer (20) may determine peak usage periods for the dispensing machine (5). For example, the control computer (20) may determine from the data that a dispensing machine (5) in an office location is used at the highest rate (e.g., uses per hour) from 7:30 AM to 10:00 AM on weekdays, whereas a different dispensing machine (5) in a retail location is used at the highest rate from 1:00 PM to 4:00 PM on weekend days. Accordingly, the scheduling algorithm may have rules that determine servicing itineraries for a particular dispensing machine (5) having regard to these peak usage periods. For example, the rules may prohibit scheduling a service visit during the peak usage periods, or prioritize scheduling of service visits during off-peak usage periods, rather than peak usage periods.

In some embodiments, a beverage dispensing machine (5) may have an error which permits remote maintenance and/or repair. For example, the dispensing machine (5) may have a computational error requiring a machine reset. The monitoring device (10) may be operatively connected to the machine (5) to receive data indicative of the error. The monitoring device (10) may transmit this error-indicative data to the control computer (20). The control computer (20) may then generate and transmit alerts or notifications to the mobile computer (30) to prompt a service advisor to send a remote reset request to the monitoring device (10) to reinitialize the machine (5) back to an operating state. The monitoring device (10) may be operatively connected to the machine (5) in order to power off the machine, or to otherwise reset or reinitialize the machine (5), such as described in Example 4 below.

### EXAMPLES

The following examples are intended only to be exemplary of certain features or elements of the claimed invention, but are not intended to be limiting of the claimed invention.

### Example 1—Usage and Maintenance Cycle

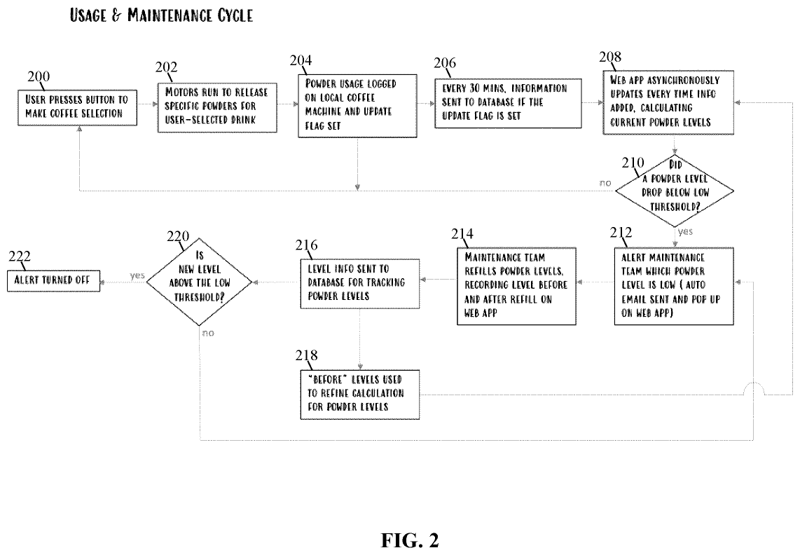

In this example, as shown in FIG. 2, the monitoring device monitors machine usage. At step (200), a cycle begins with a consumer presses a button on the coffee dispensing machine (5) to make a selection. At step (202) the dispensing machine (5) motors run to dispense powders specific to the selection to produce the desired beverage. At step (204) The powder usage is logged on the monitoring device (10), which sets an update flag. At step (206), if an update flag is set, product level information is transmitted to the control computer (20).

At step (208), the control computer (20) then asynchronously updates its database, determining current powder levels for the dispensing machine (5). At step (210), the control computer (20) determines if the powder level is below a pre-determined threshold value. If yes, then at step (212) a maintenance alert is created which identifies the powder which requires replenishment. The alert may be an email or text message sent to an individual responsible for refilling powder levels, which may be viewed on the mobile service app running on the mobile computer (30).

At step (214), when refilling of powder occurs, the technician records the actual level before refill and updated level after refill using a mobile service app running on the mobile computer (30), and at step (216), the level information is stored in a database for tracking power levels. At step (218), the actual level information (i.e., before the refill) may then be used to calibrate or refine the machine calculation or determination of powder level which triggered the alert. At step (222), the maintenance alert may be automatically be turned off upon refilling the powder if at step (220) the updated level information (i.e., after the refill) is determined to be above the pre-determined threshold value, or the technician may clear the alert on the mobile service app. If not, then the method returns to step (208).

### Example 2—Refill Cycle

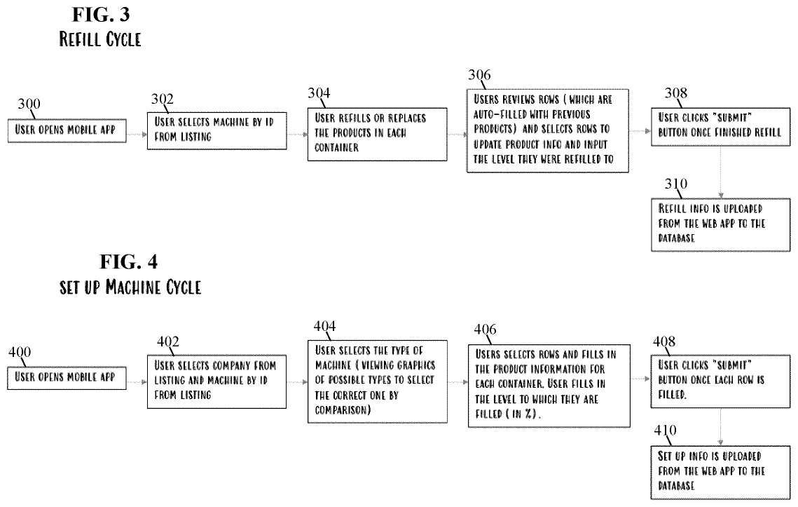

In this example, as shown in FIG. 3, a service technician uses the mobile service app running on the mobile computer (30) (step (300)) to identify and select a dispensing machine (5) which requires refilling (step (302)). After refilling the product or products (step (304)), the user updates the product levels (step (306)) and submits the updated data to the control computer (20) (step (308)), which data is uploaded to a database (step (310)).

### Example 3—Machine Setup Cycle

In this example, as shown in FIG. 4, a user sets up for first time use, either a new dispensing machine (5) or a dispensing machine (5) which is returning into service after repair or relocation. The user uses the mobile service app running on the mobile computer (30) (step (400)) to identify and select the dispensing machine (5) (step (402)) and its type (step (404)), identify and select each different product stored in the dispensing machine (5), and enter product level information, such as by a percentage value (step (406)). The entered data is then submitted to the control computer (20) (step (408)), which data is uploaded to a database (step (410)).

### Example 4—Monitoring Device

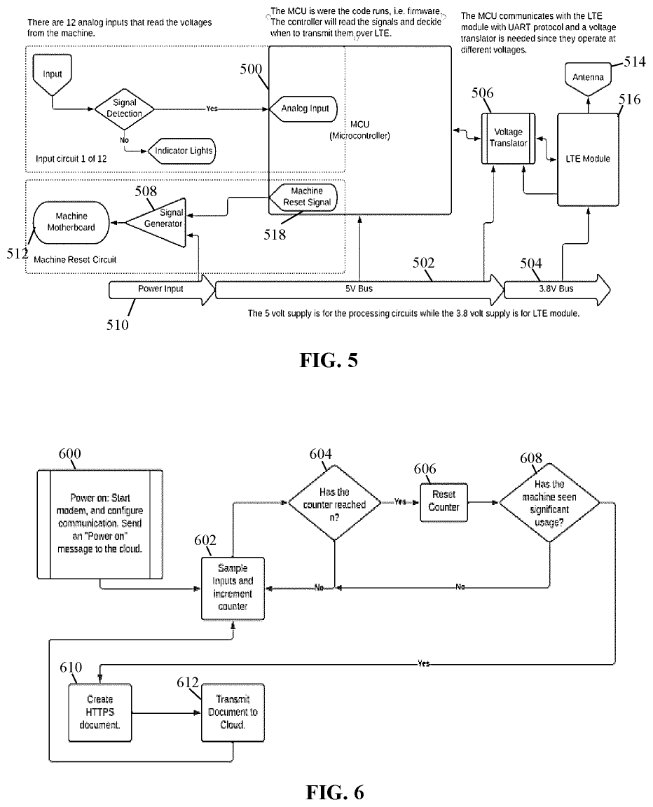

An exemplary monitoring device (10) is shown schematically in FIG. 5 and its operation is schematically depicted in FIG. 6. A processor in the form of a microcontroller (MCU) (500) is configured to monitor inputs from sensors which detect voltage pulses from machine motors or switches of the dispensing machine (5). A counter is maintained for each input which is incremented as the dispensing machine (5) is used. The MCU has stored threshold values for each counter.

In some cases, the microcontroller and input monitoring modules may require a different voltage than the communication module (e.g., LTE cellular module), which will require separate power buses (502, 504) and a voltage translator (506) for operable communication between the two.

Referring to FIG. 6, the monitoring device is powered on (step (600)). The monitoring device increments a counter for inputs as the dispensing machine is used (step (602)). If the counter for any specific input has reached a threshold value “n” (step (604)), then a notification is prepared and transmitted to the control computer (20). The counter may be reset (step (606)). In addition to, or in the alternative to counting specific inputs, the MCU (500) may also monitor other metrics of inputs from sensors of the beverage dispensing machine (5), as a precondition to generating and transmitting a notification to the control computer (20), and/or to assign an urgency level to the notification. This may allow for more refined predictive analytics of the system. As a non-limiting example, as shown in FIG. 6, the MCU may perform a logical test labelled “Has the machine seen significant usage?” (step (608)) by using a computer clock to measure an elapsed time of usage of the beverage machine (5) since the last reset of the counter. The MCU (500) may use this elapsed time to calculate a consumption rate of a product used to prepare beverages. For example, the aforementioned counter may be indicative of a number of motor or switch activations, each corresponding to consumption of a unit quantity of a particular product for preparing a beverage. The MCU may calculate a time-based consumption rate of the product by dividing the counter by the elapsed time, and then use the consumption rate to determine an urgency level for the notification. For example, a range of lower consumption rate values may result in the MCU assigning a “green” non-urgent categorization to the notification, which results in the operations following the “no” return loop in FIG. 6 to return to the step labelled “Sample Inputs and Increment Counter.” In contrast, a range of intermediate consumption rate values may result in the MCU assigning a “yellow” moderate urgency categorization to the notification, and a range of higher consumption rate values may result in the MCU assigning a “red” high urgency categorization to the notification. The elapsed time exceeding a threshold, and/or a “yellow” or “red” urgency categorization may result in the operation following the “yes” path in FIG. 6 to the step “Create HTTPS document” (step (610))). At step (612), the MCU then creates a data stream or file (e.g., a HTTPS format document) based on the counter (e.g., by including an indicator of the quantity of product units to be replenished) and/or the significant usage determination (e.g., by including the calculated product consumption rate, and/or the urgency categorization), and controls the communications module to transmit the data stream or file (e.g., wirelessly using the LTE cellular module and antenna) to a database (e.g., a cloud database, as shown in FIG. 1), which forms part of or is accessible to the control computer (20).

Referring to FIG. 5, the monitoring device (10) also includes a signal generator (508) operatively connected to a power input (510). The signal generator may be any suitable electronic device that can generate an electronic signal, such as an analog signal generator, a digital signal generator or a RF signal generator, as known in the art. The MCU (500) is operatively connected to the signal generator (508) to control the generation of the electronic signal by the signal generator (508). The signal generator (508) is also operatively connected to the electronic circuitry of the beverage dispensing machine (5) that can reset or reinitialize the beverage dispensing machine back to an operating state. For example, in FIG. 5, this electronic circuitry includes a printed circuit board labelled as “Machine Motherboard” (512), which may include one or more electronic switches to interrupt and reconnect a power supply to one or more electronic components of the beverage dispensing machine (50). In embodiments, the operative connection between the signal generator (508) and the electronic circuitry (512) of the beverage dispensing machine (5) may include wired signal connections, wireless signal connections, or a combination of wired and wireless signal connections. The MCU (200), signal generator (508), and the Machine Motherboard (512), collectively form a “Machine Reset Circuit.” In use, the MCU (500) may receive, via the Antenna (514) and LTE module (516), a remote reset request from a mobile computer (30) to reset or reinitialize the beverage dispensing machine (5) back to an operating state. In response to the request, the MCU controls the signal generator to generate a “Machine Reset Signal” (518). The Machine Reset Signal (518) is transmitted by the signal generator (508) to the Machine Motherboard (512). In response thereto, the Machine Motherboard (512) may execute instructions stored in a memory to switch power “on” or “off” to one or more electronic components of the beverage dispensing machine (5), or perform some other operation (e.g., initiating a power cycle to run a motor) in respect to the electronic component(s) of the beverage dispensing machine (5), in an attempt to reset or reinitialize the machine (5) for normal operation, or for diagnostic “troubleshooting” purposes.

### Example 5—Machine Learning for Predicting Service Requirements

The control computer (20) may employ a machine learning or artificial intelligence model to predict service requirements for a part of a dispensing machine (5). The machine learning model may leverage the vast data that may be collected from the plurality of dispensing machines (5) to predict service requirements that are expected to prevent or reduce malfunctions of the dispensing machines (5), without over-maintaining them. The prediction of service requirements can account for factors such as the location of a dispensing machine (5), its operation (e.g., usage frequency, product consumption rates, types of beverages made), past servicing history, and intrinsic construction (e.g., part type or quality). The scheduling algorithm of the control computer (20) incorporates a service action based on the service requirement into a servicing schedule for the dispensing machine (5).

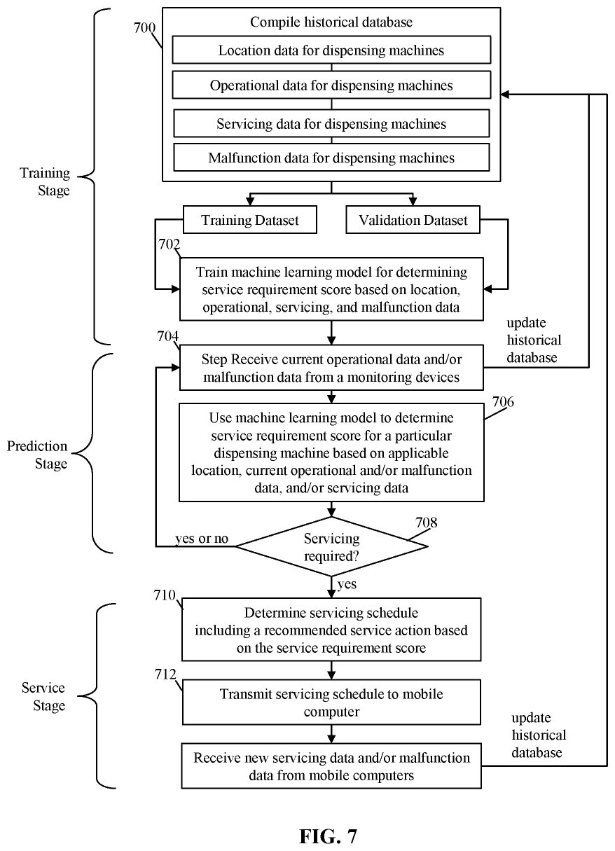

FIG. 7 shows a schematic depiction of an embodiment of such a method. The method generally includes three stages: a training stage: a prediction stage: and a servicing stage.

In the training stage, a machine learning (ML) model is trained for determining a service requirement score. The service requirement score may be a numeric value that is specific to a particular part of the dispensing machine (5). A higher service requirement score may indicate a higher probability of malfunction of the part of the dispensing machine (5), and therefore a higher need for servicing of the part.

In order to train the machine learning model, a historical database is compiled (step (700)). In embodiments, the historical database is the same database that is comprised by or accessible to the control computer (20) for storing and retrieving data generated by monitoring devices (10) and mobile computers (30), as previously described. The historical database may also include data from other sources (e.g., experimental data).

The historical database includes data relating to a plurality of dispensing machines (5), including their location data, operational data, servicing data, and malfunction data. Although the historical database aggregates data for a plurality of dispensing machines (5), the data may remain associated or linked to a particular dispensing machine (5) so that correlations still exist between malfunction data, and the location data, operational data, and servicing data.

Location data describes a geographic position a dispensing machine (5). As noted above, each dispensing machine (5) has a known location, and this may be stored in the historical database as location data.

Operational data describes parameters relating to the usage or performance of the dispensing machine (5). Operational data may include usage information (e.g., number of uses, and time in use) of the dispensing machine (5). Usage information may be sourced or derived from data collected by the usage sensors of monitoring devices (10).

Operational data may also include product consumption data (e.g., production consumption rate, volumes, or counts). For example, higher consumption rates of certain products (e.g., coffee grounds) in comparison to other products (e.g., cold drink concentrates) would be expected to result in higher wear of certain components (e.g. grinders for coffee beans, and heating elements for water). Production consumption data may be sourced or derived from data collected by the product sensors of monitoring devices (10).

Operational data may also include performance data of particular parts of the dispensing machines (5). Performance data may be sourced or derived from data collected by the usage sensors, the product sensors, or other sensors of the monitoring devices (10) or the dispensing machines (5). Non-limiting examples of such other sensors include electrical current and voltage meters, thermometers, water pressure sensors, water flow sensors, and actuation counters, etc.

To illustrate, a typical dispensing machine (5) is made of numerous parts such as heating elements, motors, pumps, vacuums, boilers, temperature sensors, fans, valves, gaskets, pistons, filters, dispensers, nozzles, grinders, blades, bowls, chambers, buckets, trays, tubes, keypads, touchscreens, card readers and other payment acceptance mechanisms, and so forth. As an example, the performance and longevity of parts such as heating elements, motors, filters, and temperature sensors can be negatively impaired by high water hardness that results in calcium buildup on the parts. Water hardness is location specific, and therefore location data of the dispensing machine (5) may be correlated with the probability of malfunctions related to water hardness. To compensate for calcium buildup on a heating element, the power unit of the dispensing machine (5) may need to supply higher electrical power to the heating element to regulate temperature inside the boiler, but this makes the heating element more susceptible to breakage. Likewise, high water hardness may impair performance and/or longevity of motors, sensors, filters, and other parts of the dispensing machine (5). Impairment or malfunction of these parts may be indicated by physically detectable changes, such as variations in, or abnormal or suboptimal levels of electrical supply parameters (e.g., consumption, voltage, or current) for electrical parts, part temperatures, or water pressures, temperatures, or flows. Accordingly, the monitoring device (10) may comprise suitable sensors for measuring performance data that is relevant to the functioning and/or longevity of specific parts of the dispensing machine (5) that are to be serviced.

Servicing data describes service actions performed on a dispensing machine (5). Servicing data may describe the particular part of the dispensing machine (5) for which a service action was performed, the nature of the service action performed (e.g. inspection, cleaning, lubrication, repair, replacement, replenishment, etc.), the nature of replacement part (e.g., part identifiers, and part quality) used in a service action, and when the service action was performed. Servicing data may be sourced from data input by service technicians using the mobile service app running on the mobile computers (30).

Malfunction data indicates a state of error, failure, or unacceptable performance of a part of a dispensing machine (5). Malfunction data may be sourced or derived from data indicating an error or a need for reset the dispensing machine, as previously described. Malfunction data may also be derived from performance data that is sourced or derived from data collected by the monitoring devices (10). For example, malfunction data may be derived from a parameter of electrical power supplied to an electrical part, or the temperature, pressure or flow rate of water through a part of the dispensing machine (5) being outside of a normal operating range. Malfunction data may also be sourced or derived from data input by service technicians using the mobile service app running on the mobile computers (30). For example, malfunction data may be derived from a diagnosis or an order for a replacement part entered by a service technician into the mobile service app and submitted to the control computer (20).

Once the historical database has been populated, the database may be divided into a training dataset, and a non-overlapping validation dataset. At step (702), using a computer-implemented training platform of the control computer (20), the machine learning model is trained on the training dataset to define values of variable parameters of the machine learning model to accurately and reliably relate the malfunction data to the location data, operational data, and/or servicing data. Although training of the machine learning model may involve none or some human supervision, it will be understood that that training platform determines the values of the variable parameters of the machine learning model, without having to be explicitly determined by a human user. The selection and implementation of a particular machine learning model, and training platform will be within the skill of a person of ordinary skill in the art. Non-limiting examples of the machine learning models that may be used include models based on artificial neural networks (ANN), regression, decision trees, Bayesian networks, support-vector machines, data clustering approaches, and so forth. Suitability of a particular machine learning model and training platform will depend on factors such as the data format, the size of the dataset, and computational limitations, as known to persons skilled in the art.

The validation dataset may be used to measure the accuracy of the machine learning model, as trained using the training dataset. The validation process may be performed by a computer-implemented validation platform of the control computer (20) to detect inaccuracies due to “under fitting” or “over fitting” of the machine learning model. The machine learning model with modification may be re-trained by the training platform, as necessary, until the accuracy of the machine learning model for the validation dataset is acceptable.

The prediction stage uses the trained machine learning model to predict whether servicing of the dispensing machine is required. At step (704), the control computer (20) receives current operational data and/or malfunction data from a monitoring devices (10) as the dispensing machines (5) are operated. (In this context “current” is refers to data being more recent in time than the historical data.) The current data may be added to the historical database as previously described.

At step (706), in respect to a particular dispensing machine (5), the control computer (20) uses the machine learning model to process current operational and/or malfunction data. as well as the location data and servicing data applicable to that dispensing machine (5), to determine a service requirement score for that dispensing machine (5). This processing may be continuous and repetitive, and based on instantaneous current data or cumulative current data over a time period for a particular dispensing machine (5). If the service requirement score is sufficiently high (step (708)), then the control computer (20) may determine that servicing of a particular part of the dispensing machine (5) is required.

In the service stage, at step (710), the control computer (20) implements its scheduling algorithm to determine a servicing schedule, including a required service action. For example, if the machine learning model determined a high service requirement score for a heating element of the dispensing machine (5), then the scheduling algorithm may then determine a servicing schedule which includes a recommended service action related to the heating element. The recommended service action may be selected from different possible service actions, and the timing of the service action may be based on the service requirement score. For example, the scheduling algorithm may recommend a part replacement action, and a more immediate service time for a higher service requirement score, as opposed to an inspection action and later service time for a lower service requirement score.

At step (712), the control computer (20) transmits the servicing schedule to the mobile computer (30) used by the service technician. In other embodiments, the control computer (20) may simply send an alert or notification to the mobile computer (30) that servicing of the part of the dispensing machine (5) is required. When the service technician makes the service visit, the service technician may use the mobile computer (30) to enter new servicing data or malfunction data in respect to the dispensing machine (5) (step (714)). The new data may be added to the historical database as previously described.

### Interpretation.

Aspects of the present invention may be described with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

The flowchart and block diagrams in the Figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The corresponding structures, materials, acts, and equivalents of all means or steps plus function elements in the claims appended to this specification are intended to include any structure, material, or act for performing the function in combination with other claimed elements as specifically claimed.

References in the specification to “one embodiment”, “an embodiment”, etc., indicate that the embodiment described may include a particular aspect, feature, structure, or characteristic, but not every embodiment necessarily includes that aspect, feature, structure, or characteristic. Moreover, such phrases may, but do not necessarily, refer to the same embodiment referred to in other portions of the specification. Further, when a particular aspect, feature, structure, or characteristic is described in connection with an embodiment, it is within the knowledge of one skilled in the art to affect or connect such module, aspect, feature, structure, or characteristic with other embodiments, whether or not explicitly described. In other words, any module, element or feature may be combined with any other element or feature in different embodiments, unless there is an obvious or inherent incompatibility, or it is specifically excluded.

It is further noted that the claims may be drafted to exclude any optional element. As such, this statement is intended to serve as antecedent basis for the use of exclusive terminology, such as “solely,” “only,” and the like, in connection with the recitation of claim elements or use of a “negative” limitation. The terms “preferably,” “preferred,” “prefer,” “optionally,” “may,” and similar terms are used to indicate that an item, condition or step being referred to is an optional (not required) feature of the invention.

The singular forms “a,” “an,” and “the” include the plural reference unless the context clearly dictates otherwise. The term “and/or” means any one of the items, any combination of the items, or all of the items with which this term is associated. The phrase “one or more” is readily understood by one of skill in the art, particularly when read in context of its usage.

The term “about” can refer to a variation of +5%, +10%, +20%, or +25% of the value specified. For example, “about 50” percent can in some embodiments carry a variation from 45 to 55 percent. For integer ranges, the term “about” can include one or two integers greater than and/or less than a recited integer at each end of the range. Unless indicated otherwise herein, the term “about” is intended to include values and ranges proximate to the recited range that are equivalent in terms of the functionality of the composition, or the embodiment.

As will be understood by one skilled in the art, for any and all purposes, particularly in terms of providing a written description, all ranges recited herein also encompass any and all possible sub-ranges and combinations of sub-ranges thereof, as well as the individual values making up the range, particularly integer values. A recited range includes each specific value, integer, decimal, or identity within the range. Any listed range can be easily recognized as sufficiently describing and enabling the same range being broken down into at least equal halves, thirds, quarters, fifths, or tenths. As a non-limiting example, each range discussed herein can be readily broken down into a lower third, middle third and upper third, etc.

As will also be understood by one skilled in the art, all language such as “up to”, “at least”, “greater than”, “less than”, “more than”, “or more”, and the like, include the number recited and such terms refer to ranges that can be subsequently broken down into sub-ranges as discussed above. In the same manner, all ratios recited herein also include all sub-ratios falling within the broader ratio.

1. A system for monitoring a plurality of beverage dispensing machines, the system for use with a mobile computer, the system comprising:
(a) a plurality of monitoring devices, wherein each one of the monitoring devices is associated with a different one of the machines, and comprises at least one sensor for generating data comprising any one or a combination of:
(i) product level data indicative of a quantity of a product available for consumption by the one of the machines; or
(ii) usage data indicative of a number of activations or a total elapsed activation time of the one of the machines; or
(iii) error data indicative of an error in operation of the one of the machines;
(b) a control computer in communication via a communications network with the monitoring devices, and comprising: a processor and a non-transitory computer readable medium storing instructions executable by the processor to implement a method comprising the steps of:
(i) receiving the data generated by the sensors; and
(ii) generating a notification based on the data generated by the sensors; and
(iii) transmitting the notification to the mobile computer.

2. The system of claim 1 wherein the method further comprises the step of making a determination of whether a quantity of the product available for consumption by one of the machines is below a pre-determined threshold level based on the consumption data, and wherein steps (ii) and (iii) of the method are conditional on making the determination.

3. The system of claim 1 wherein the monitoring device further comprises a processor configured to make a determination of whether the product level data or usage data is above or below a threshold value, and to transmit the data to the control computer conditional on making the determination.

4. The system of claim 1 wherein the method further comprises the steps of: receiving, from the mobile computer, updated product level data; and storing the updated product level data in a database.

5. The system of claim 1 wherein the method further comprises the steps of: receiving, from the mobile computer, actual product level data; and calibrating a determination of the quantity of the product available for consumption by the one of the machines based on the actual product level data.

6. The system of claim 1 wherein the notification comprises a report comprising the product level data.

7. The system of claim 1 wherein the notification comprises an alert for servicing one or more of the machines.

8. The system of claim 1 wherein the notification comprises a schedule for service visits to one or more of the machines.

9. The system of claim 8 wherein the method further comprises the step of calculating travel distances for the service visits based on location data for the machines, and wherein generating the schedule for service visits is further based on the calculated distances.

10. The system of claim 8 wherein the method further comprises the step of determining a service priority level for the machines based on the data generated by the sensors, and wherein generating the schedule for service visits is further based on the determined priority levels.

11. The system of claim 8 wherein the method further comprises the step of determining service times for the service visits, and the schedule for service visits comprises the service times.

12. The system of claim 11 wherein the method further comprises the step of determining peak usage periods for the machines based on the data generated by the sensors, and determining the service times for the service visits is based on the peak usage periods.

13. The system of claim 1 wherein generating the schedule for service visits is further based on a machine learning model trained using one or a combination of location data, operational data, servicing data, or malfunction data for the machines.

14. The system of claim 1 wherein the method is performed repeatedly on a periodic basis.

15. The system of claim 1 wherein the method is performed in response to a request received from the mobile computer.

16. The system of claim 1 wherein transmitting the notification comprises transmitting an email or a text message.

17. (canceled)

18. A method for monitoring a plurality of beverage dispensing machines, the method implemented by a control computer and for use with a mobile computer, the method comprising the steps of:
(a) receiving data from a plurality of monitoring devices in communication via a communications network with the control computer, wherein each one of the monitoring devices is associated with a different one of the machines, and wherein the data comprises any one or a combination of:
(i) product level data indicative of a quantity of a product available for consumption by the one of the machines; or
(ii) usage data indicative of a number of activations or a total elapsed activation time of the one of the machines; or
(iii) error data indicative of an error in operation of the one of the machines;
(b) generating a notification based on the data generated by the sensors; and
(c) transmitting the notification to the mobile computer.

19. The method of claim 18 further comprising the step of making a determination of whether a quantity of the product available for consumption by one of the machines is below a pre-determined threshold level based on the consumption data, and wherein steps (ii) and (iii) of the method are conditional on making the determination.

20-34. (canceled)

35. A device for monitoring a beverage dispensing machine, the device comprising:
(a) at least one sensor for generating data comprising any one or a combination of:
(i) product level data indicative of a quantity of a product available for consumption by the machine; or
(ii) usage data indicative of a number of activations or a total elapsed activation time of the machine; or
(iii) error data indicative of an error in operation of the machine; and
(b) a communication module for transmitting the data to a communications network.

36-37. (canceled)

38. The system of claim 1, wherein a beverage dispensing machine further comprises:
(a) a signal generator for generating a machine reset signal to an electronic circuit of the machine to reset the machine; and
(b) a processor for receiving a reset request from a communications network, and configured to control the signal generator to generate the machine reset signal in response to receiving the reset request.

39. The method of claim 18 comprising the further steps of:
(a) using a processor to receive a reset request from a communications network; and
(b) using the processor, in response to receiving the reset request, controlling a signal generator to generate a machine reset signal to an electronic circuit of the machine to reset the machine.
